(19) United States
(12) Patent Application Publication
(10) Pub. No.: US 2024/0302034 A1
(43) Pub. Date: Sep. 12, 2024

(54) WATERPROOF LIGHT BULB

(71) Applicant: Hongbing ZHENG, Hangzhou (CN)

(72) Inventor: Hongbing ZHENG, Hangzhou (CN)

(21) Appl. No.: 18/118,158

(22) Filed: Mar. 7, 2023

(51) Int. Cl. F21V 31/00; F21S 4/10; F21V 3/04; F21V 23/06

(52) U.S. Cl. CPC F21V 31/005; F21S 4/10; F21V 3/04; F21V 23/06

(57) ABSTRACT

A waterproof light bulb and a light string are provided. The light bulb includes an inner bulb socket; an outer bulb socket partially enclosing the inner bulb socket; and at least one globe, wherein one of the at least one globe is connected to the inner bulb socket; wherein the inner bulb socket includes a plug, a first pointed strip, a second pointed strip, and a base, wherein the first pointed strip and the second pointed strip are attached to the base. During installation, the plug is pressed against the base, so that the first pointed strip, and the second pointed strip pierce plastic coating of wires clamped between the plug and the base, and get in contact with cores of the wires. Each of the first pointed strip and the second pointed strip may comprise a piercing section and each piercing section has a pointed tip extending upwards.

### FIELD OF TECHNOLOGY

The present disclosure generally relates to electronic lighting devices, in particular, to a waterproof light bulb.

### BACKGROUND

Lighting devices are ubiquitous in everyday life. They are able to provide illumination once powered, and some lighting devices also emit light with colors or patterns and can serve as great decorations. Among decorative lighting devices, light strings are the most widely used partially because they are cheap and easy to install.

However, light bulbs of existing light strings are mostly not waterproof and thus cannot be used outdoors for a long time.

### SUMMARY

The present disclosure provides a waterproof light bulb, comprising: an inner bulb socket; an outer bulb socket partially enclosing the inner bulb socket; and at least one globe, wherein one of the at least one globe is connected to the inner bulb socket; wherein the inner bulb socket includes a plug, a first pointed strip, a second pointed strip, and a base, wherein the first pointed strip and the second pointed strip are attached to the base.

In an embodiment, during installation, the plug is pressed against the base, so that the first pointed strip, and the second pointed strip pierce plastic coating of wires clamped between the plug and the base, and get in contact with cores of the wires.

In an embodiment, each of the first pointed strip and the second pointed strip comprises a piercing section and each piercing section has a pointed tip extending upwards.

In an embodiment, each of the first pointed strip and the second pointed strip comprises a horizontal section connected with a corresponding piercing section, wherein the horizontal sections extend horizontally, and are perpendicular to the piercing sections.

In an embodiment, the first pointed strip and the second pointed strip are made of copper.

In an embodiment, the base comprises a wire slot extending horizontally through the base and exposed from a top surface of the base.

In an embodiment, the at least one globe comprises an inner globe, which comprises a shell, and a connecting portion; and the connection portion connects the shell to the inner bulb socket.

In an embodiment, the at least one globe comprises an outer globe partially enclosing the inner globe and connected to the outer bulb socket, wherein the outer globe has a main body and a movable cover under the main body.

In an embodiment, during installation, the movable cover is detached from the main body to leave an opening at a bottom of the outer globe, sand then the inner globe is extended into the outer globe from the bottom of the outer globe.

In an embodiment, the connecting portion is an Edison Screw, and the inner bulb socket comprises female threads.

In an embodiment, the outer bulb socket comprises a hanger, wherein the hanger comprises a top portion that includes a hang hole, and a bottom portion connected to other parts of the outer bulb socket.

In an embodiment, the hang hole is triangular.

In an embodiment, the hanger is extendable.

In an embodiment, the outer bulb socket is formed by injection molding.

### BRIEF DESCRIPTION OF THE DRAWINGS

FIG. 1 shows an exploded view of a light bulb according to one embodiment of the present disclosure.

FIG. 2 is a perspective view showing an inner bulb socket and an outer bulb socket according to one embodiment of the present disclosure.

FIG. 3 shows an exploded view of an inner bulb socket according to one embodiment of the present disclosure.

FIG. 4a is a front view of a light bulb with its hanger extending upwards according to one embodiment of the present disclosure.

FIG. 4b is a front view of the light bulb with the hanger retracted according to one embodiment of the present disclosure.

FIG. 4c is an exploded view showing the hanger and an outer bulb socket of the light bulb according to one embodiment of the present disclosure.

FIG. 5 is an exploded view showing two pointed strips and a base of an inner bulb socket according to one embodiment of the present disclosure.

FIG. 6 shows an exploded view of a light bulb according to one embodiment of the present disclosure.

FIG. 7 is a perspective view showing an inner bulb socket and an outer bulb socket according to one embodiment of the present disclosure.

### DETAILED DESCRIPTION

One or more specific embodiments of the present disclosure will be described below. These described embodiments are only examples of the presently disclosed techniques, and are not intended to limit aspects of the presently disclosed invention. Additionally, in an effort to provide a concise description of these embodiments, all features of an actual implementation may not be described in the specification. It should be appreciated that in the development of any such actual implementation, numerous implementation-specific decisions must be made to achieve the developers' specific goals, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The terms regarding spatial relationships such as “lower,” “below,” “under,” and “on,” “above,” etc., are used for convenience of description to describe the relationship of one element or feature to another element or feature in a figure. It should be understood that in addition to the orientation shown in the figure, the spatial relationship terms are intended to include different orientations during use and operation. For example, if the device in the figures is rotated, then what is described as “below” or “beneath” or “under” may become “on” or “above” or “over.” Thus, the term “below” and “under” may include both upper and lower orientations. Device may additionally be oriented differently (e.g., rotated 90 degrees or other orientations), and the spatial relationship used in this description are interpreted accordingly.

### Embodiment 1

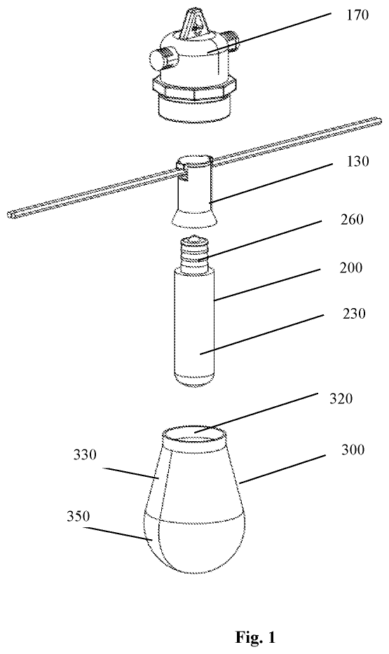

FIG. 1 shows an exploded view of a light bulb according to embodiment 1 of the present disclosure. The light bulb includes an inner bulb socket 130, an outer bulb socket 170, an inner globe 200, and an outer globe 300.

In one example, the outer globe 300 is in the shape of a pear, with its upper portion smaller than its lower portion, and there is an opening 320 on the top of the outer globe 300. The inner globe 200 includes a shell 230 outside a filament, and a connecting portion 260, for example, an Edison Screw, connected to the filament and the shell 230. In one embodiment, the inner globe 200 is in the shape of a stick, and the shell 230 of the inner globe 200 has a diameter smaller than that of the opening 320 of the outer globe 300, and can be extended into the outer globe 300 through the opening 320.

In one example, the inner globe 200 encloses an LED chip, and the LED chip is connected to the connecting portion 260.

The inner globe 200 may be made of glass, transparent polymers, or other insulators that are transparent or translucent. The outer globe 300 may be made of glass, transparent polymers, or other insulators that are transparent or translucent. In one embodiment, there are patterns formed on the outer globe 300.

When installed, the inner globe 200 is electrically connected to the inner bulb socket 130 through the connecting portion 260. In one example, the inner bulb socket 130 includes female threads on its internal surface, and the inner globe 200 is screwed into the inner bulb socket 130 when installed.

When installed, the outer globe 300 encloses the inner globe 200 and is connected to the outer bulb socket 170. In one embodiment, the outer globe 300 may be screwed into the outer bulb socket 170. In some other embodiments, the outer globe 300 may be attached to the outer bulb socket 170 through magnets.

In one example, the shell of the inner globe 200 is in the shape of a pear, with its upper portion smaller than its lower portion. Accordingly, the outer globe 300 in this embodiment has two separate parts: a main body 330, and a movable cover 350 under the main body 330. The movable cover 350 and the main body 330 may be one-piece, and the movable cover can rotate around a connector between the movable cover 330 and the main body 330; they may also be two pieces, in which case the movable cover is detachable from the main body. During installation, the movable cover 350 is either rotated or detached from the main body 330 to leave an opening at the bottom of the outer globe 300, so that the inner globe 200 can be extended into the outer globe 300 from the bottom of the outer globe 300, and then connected to the inner bulb socket 130; then the movable cover 330 is restored to cover the opening at the bottom of the outer globe 300.

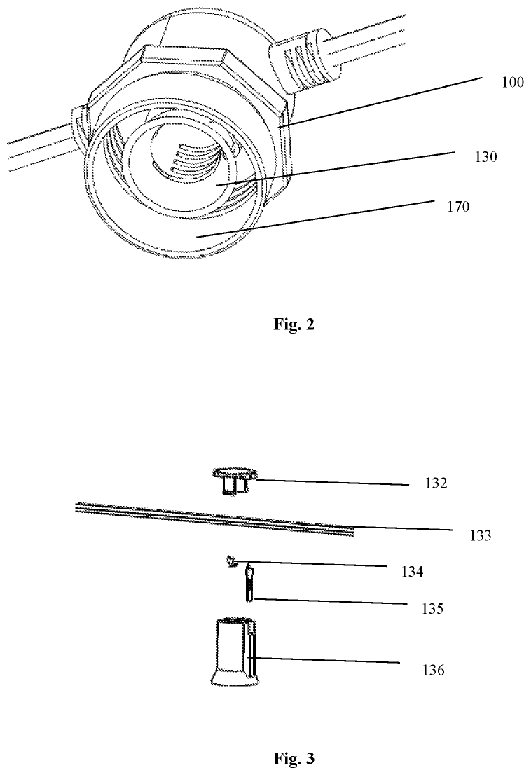

FIG. 2 is a perspective view showing the inner bulb socket 130 and the outer bulb socket 170. As shown in FIG. 2, the inner bulb socket 130, and the outer bulb socket 170 form a bulb socket 100, where the outer bulb socket 170 partially encloses the inner bulb socket 130.

In one example, the outer bulb socket 170 is made of plastic materials and is formed by one-piece injection molding, which makes it more waterproof. The inner bulb socket 130 may be made of metal, or plastic.

In one embodiment, the outer bulb socket 170 and the inner bulb socket 130 both include female threads on their internal surfaces.

FIG. 3 shows an exploded view of the inner bulb socket 130. The inner bulb socket 130 includes a plug 132, a first pointed strip 134, a second pointed strip 135, and a base 136.

The plug 132 includes a plate with a size and shape matching a cross section of the base 130. In one embodiment, the plug 132 also includes two legs connected to the plate and formed under the plate. The two legs are spaced apart and opposite to each other.

The first pointed strip 134, and the second pointed strip 135 are detachably or fixedly attached to the base 136 and are arranged along a diagonal of the cross section of the base 136. In FIG. 3, the strips are shown to be separated from the base 136 for ease of understanding. The first pointed strip 134, and the second pointed strip 135 are made of metal, and in one embodiment, they are made of copper.

During installation, the plug 132 is pressed against the base 136, so that the first pointed strip 134, and the second pointed strip 135 pierce plastic coating of wires clamped between the plug 132 and the base 136, and get in contact with cores of the wires.

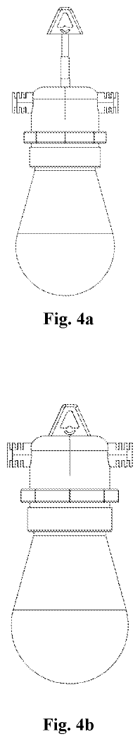

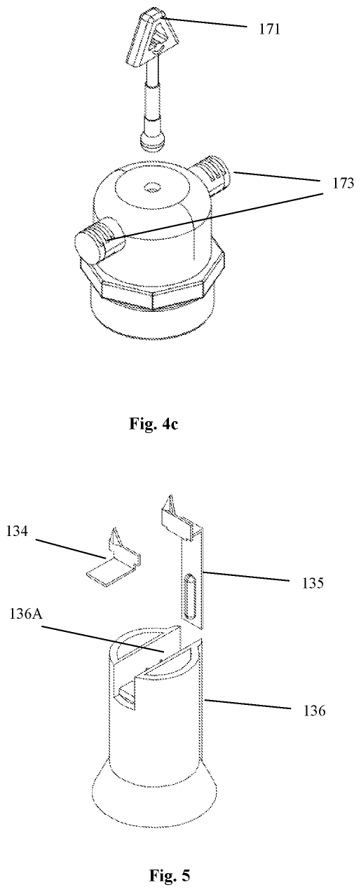

In some examples, as shown in FIGS. 4a-4c, the outer bulb socket 170 further includes a hanger 171.

The hanger 171 includes a top portion that includes a hang hole, and a bottom portion connected to other parts of the outer bulb socket 170. In some embodiments, the hanger 170 is extendable; in particular, the bottom portion of the hanger 171 may include a plurality of tubes that are in clearance fit and sleeved together, as shown in FIGS. 4a-4b.

The hang hole may be an upright triangle, which ensures that, e.g. a hook, can be in stable contact with a top vertex of the triangular hang hole. The hang hole may also be circular, rectangular, etc.

In some examples, the lower end of the bottom portion of the hanger 171 is ball shaped, as shown in FIG. 4c; when installed, the ball-shaped lower end is inside the outer bulb socket 170, and the bottom portion of the hanger extends through an opening on a top surface of the outer bulb socket 170. The opening on the top surface of the outer bulb socket 170 is a through hole in a top layer of the outer bulb socket 170, and there is a water blocking layer beneath the top layer, so that water will not come inside the outer bulb socket 170 and get in contact with the wires, the inner bulb socket 130, or the inter globe 200.

As shown in FIGS. 4a-4c, the outer bulb socket 170 also includes a pair of ears 173 formed on two sides of the outer bulb socket 170, the ears 173 allow electrical wires to go through the outer bulb socket 170. The electrical wires are thus also able to support the entire bulb when the hanger 171 is not in use, which further widens the scope of application of the present disclosure. In some examples, the electrical wires also string up the outer bulb socket 170 and the inner bulb socket 130, so the latter two are able to stay together when connections between them get loose. In some examples, the outer bulb socket 170 and the inner bulb socket 130 are formed in one piece.

FIG. 5 is an exploded view showing the two pointed strips and the base 136.

The base 136 further includes a wire slot 136A horizontally extending through the base 136 and exposed from a top surface of the base 136. The wire slot 136A allows electrical wires to go through the base 136.

During installation, the plug 132 is pressed against the electrical wires extending through the wire slot 136A of the base 136, so that the first pointed strip 134, and the second pointed strip 135 pierce plastic coating of the electrical wires clamped between the plug 132 and the base 136, and get in contact with cores of the electrical wires.

In one example, each of the first pointed strip 134 and the second pointed strip 135 is provided with a piercing section. Each piercing section has a pointed tip extending upwards. The pointed tips of the first pointed strip 134 and the second pointed strip 135 are parallel in some embodiments. The pointed tips are triangular, for example; they may also be of any other shape that has an acute portion, for example, an irregular polygon formed by a rectangle and a triangle.

In one example, each of the first pointed strip 134 and the second pointed strip 135 is provided with a horizontal section connected with a corresponding piercing section. The horizontal sections extend horizontally, and are perpendicular to the piercing sections. That is, the first pointed strip 134 and the second pointed strip 135 are bent, which increases contact areas between the pointed strips and the electrical wires.

### Embodiment 2

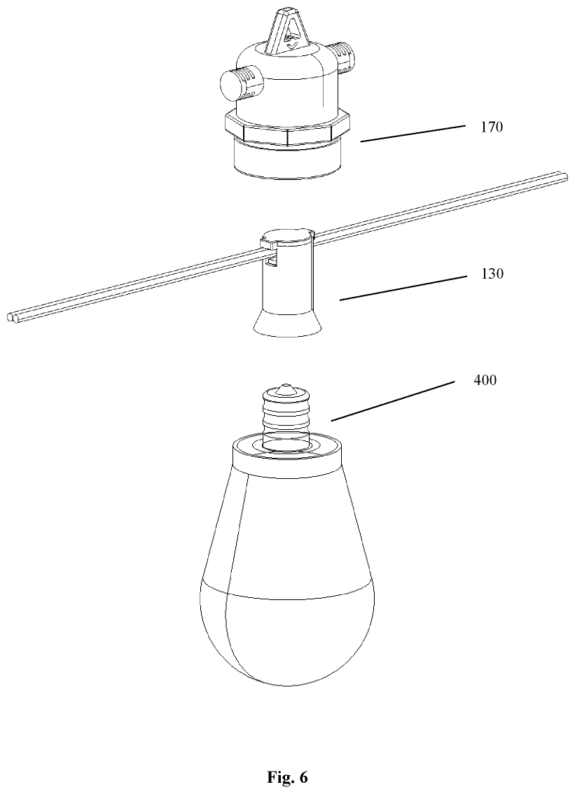

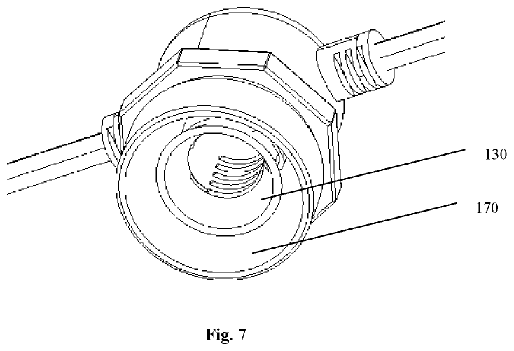

The present disclosure also provides a light bulb that includes an inner bulb socket 130, an outer bulb socket 170, a globe 400 according to Embodiment 2 of the present disclosure, as shown in FIG. 6, and FIG. 7.

Embodiment 2 mainly differs from Embodiment 1 in that the light bulb in Embodiment 2 includes only one globe 400 connected to the inner bulb socket 130. As an example, the outer bulb socket 170 of Embodiment 2 has no female threads, as shown in FIG. 7. Many elements in FIG. 6 and FIG. 7 may correspond to their respective counterparts in FIG. 1 and other figures, and may have substantially the same features and functionalities as described above.

### Embodiment 3

The present disclosure also provides a light string, including a plurality of light bulbs and electrical wires. Each of the plurality of light bulbs may be a light bulb described in any of above-mentioned embodiments.

In summary, one or more aspects of the present disclosure have the following advantages:

1. the light bulb is conducted by copper strips pressed together, which improves the production efficiency, and the strips are bent, thereby increasing contact areas between wires and the copper strips.

2. the hanger is extendable and retractable, which makes it easier to install the light bulb, thereby widening the scope of application of the present disclosure.

3. the outer bulb socket is formed by injection molding, there are two layers of globes, and there are two corresponding bulb sockets, which all contribute to water-resistance of the light bulb.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A waterproof light bulb, comprising:
an inner bulb socket;
an outer bulb socket partially enclosing the inner bulb socket; and
at least one globe, wherein one of the at least one globe is connected to the inner bulb socket;
wherein the inner bulb socket includes a plug, a first pointed strip, a second pointed strip, and a base, wherein the first pointed strip and the second pointed strip are attached to the base;
wherein the outer bulb socket comprises a hanger, wherein the hanger comprises a bottom portion connected to other parts of the outer bulb socket, wherein the bottom portion comprises a plurality of tubes that are in clearance fit and sleeved together.

2. The waterproof light bulb according to claim 1, wherein during installation, the plug is pressed against the base, so that the first pointed strip, and the second pointed strip pierce plastic coating of wires clamped between the plug and the base, and get in contact with cores of the wires.

3. The waterproof light bulb according to claim 1, wherein each of the first pointed strip and the second pointed strip comprises a piercing section and each piercing section has a pointed tip extending upwards.

4. The waterproof light bulb according to claim 3, wherein each of the first pointed strip and the second pointed strip comprises a horizontal section connected with a corresponding piercing section, wherein the horizontal sections extend horizontally, and are perpendicular to the piercing sections.

5. The waterproof light bulb according to claim 1, wherein the first pointed strip and the second pointed strip are made of copper.

6. The waterproof light bulb according to claim 1, wherein the base comprises a wire slot extending horizontally through the base and exposed from a top surface of the base.

7. The waterproof light bulb according to claim 1, wherein the at least one globe comprises an inner globe, which comprises a shell, and a connecting portion; and the connection portion connects the shell to the inner bulb socket.

8. The waterproof light bulb according to claim 7, wherein the at least one globe comprises an outer globe partially enclosing the inner globe and connected to the outer bulb socket, wherein the outer globe has a main body and a movable cover under the main body.

9. The waterproof light bulb according to claim 8, wherein during installation, the movable cover is detached from the main body to leave an opening at a bottom of the outer globe, sand and then the inner globe is extended into the outer globe from the bottom of the outer globe.

10. The waterproof light bulb according to claim 7, wherein the connecting portion is an Edison Screw, and the inner bulb socket comprises female threads.

11. The waterproof light bulb according to claim 1, wherein the hanger further comprises a top portion that includes a hang hole.

12. The waterproof light bulb according to claim 11, wherein the hang hole is triangular.

13. The waterproof light bulb according to claim 1, wherein the hanger is extendable.

14. The waterproof light bulb according to claim 1, wherein the outer bulb socket is formed by injection molding.

15. The waterproof light bulb according to claim 1, wherein the outer bulb socket further comprises a pair of ears formed on two sides of the outer bulb socket, wherein the pair of ears allow electrical wires to go through the outer bulb socket.
